(19) United States
(12) Patent Application Publication
(10) Pub. No.: US 2003/0137143 A1
(43) Pub. Date: Jul. 24, 2003

(54) Computer printed bingo packs

(76) Inventors: Yuri Itkis, Las Vegas, NV (US); Boris Itkis, Las Vegas, NV (US)

Correspondence Address: Quirk & Tratos, Suite 500 North, 3773 Howard Hughes Parkway, Las Vegas, NV, 89109, US

(21) Appl. No.: 10/056,771

(22) Filed: Jan. 22, 2002

(51) Int. Cl. G09B 19/00

(52) U.S. Cl. 283/49

(57) ABSTRACT

A bingo pack printed by a printer responsive to a computer consisting of a plurality of bingo pages imprinted with at least one bingo card and a reference corresponding to a bingo game, including but not limited to, a game name, a game number and/or a bingo pattern. A bingo pack is dispensed to a player from a self-service computer-controlled printing kiosk. The kiosk displays a menu of available bingo packs on a touchscreen display and accepts currency, credit cards and refund vouchers. Bingo packs dispensed from the kiosk may be printed on paper of various colors, indicating a prize level. Each bingo page comprising a printed bingo pack may be imprinted with a pack identification number, date, bingo hall name, advertisement, coupon, sweepstakes identification, player's name and/or player identification number. In addition to paper bingo cards, kiosks may transmit electronic bingo cards to electronic bingo player units.

### BACKGROUND OF THE INVENTION

The present invention relates to bingo packs including a plurality of bingo pages having bingo cards printed thereon. More particularly, bingo packs which are printed by a printer responsive to a computer. Self-service kiosks provide a point-of-sale location for bingo players to purchase bingo packs.

### FIELD OF THE INVENTION

In the bingo halls, paper bingo cards are typically sold in the form of bingo booklets (“packs”), each bingo pack consisting of a number of bingo pages glued together collated at the top edge. Each bingo page typically is imprinted with either three bingo cards (“three-on”), or four bingo cards (“four-on”) and most frequently with six bingo cards (“six-on”). Typically, conventional bingo packs are manufactured using techniques disclosed in U.S. Pat. Nos. 3,822,876, 4,448,127 both to Frain and U.S. Pat. No. 5,890,432 to Rogaliner et al. Although paper bingo cards are popular with bingo players, they are costly to manufacture, expensive to ship from the factories to bingo halls and restrict large sums of money in inventories of manufactured bingo packs stored at printing factories, distributor shops and bingo halls. Even more expensive are high quality bingo packs imprinted with pack identification numbers and/or unique barcodes, such as those bingo packs manufactured by Arrow International, Inc., of Cleveland, Ohio and by BK Entertainment, Inc., of Minneapolis, Minn. A recent improvement in bingo pack manufacturing techniques is offered by U.S. Pat. No. 5,607,145 to Lovell. Lovell discloses a method of making multi-page bingo packs having imprinted page numbers on each bingo page of the pack. An advantage of such packs, known in the industry as “books of choice”, is that by being printed on the same color paper, they facilitate the process of collating the packs. However, books of choice being manufactured by large factories and being shipped to bingo halls indirectly, via bingo paper distributors, are still costly.

On the other hand, U.S. Pat. Nos. 4,882,688 and 4,885,700 both to Kondziolka et al., disclose a method of computer-printing bingo cards utilizing graphics printers. The method allows printing of custom bingo cards for special bingo games directly within the bingo hall, as is practiced for example, by Melange Computer Services, Inc., of Lansing, Mich. and by Multi-Media Games, Inc., of Tulsa, Okla. However, Kondziolka's technique is not conducive to printing regular bingo packs neither on the so-called, tractor-feed, pre-perforated computer paper nor on the conventional printer paper sold in reams. Specifically, the tractor-feed paper is expensive and difficult to separate into individual bingo packs and the conventional paper is difficult to collate into bingo packs. In addition, Kondziolka's paper cards exclude only duplicate bingo cards, whereas bingo halls require bingo cards differing from each other by four numbers or more.

### SUMMARY OF THE INVENTION

A primary objective of the present invention is low-cost, on-demand manufacturing of bingo packs.

Another objective of the present invention is printing bingo packs using inexpensive conventional graphics printers instead of expensive offset printers.

Another objective of the present invention is to avoid the added expense of color printing and print monochrome bingo packs (e.g., using conventional laser printers rather than ink-jet color printers).

It is a further objective of the present invention to decrease the overall manufacturing cost by eliminating a need for collating multiple bingo pages into a glued bingo pack.

It is another objective of the present invention to arrange bingo pages of the computer printed bingo packs in the natural order of playing individual bingo pages in a bingo session.

It is another objective of the present invention to decrease labor costs related to selling bingo packs and offset at least some portion of printing costs by generating revenue from outside sources.

Yet another objective of the present invention is to facilitate integrity of a bingo game by improving accountability for bingo cards being played.

These and other objectives will become more apparent from the following drawings and the description of the preferred embodiment.

The above objectives are achieved in the present invention by printing multiple-page bingo packs on a computer-controlled graphics printers, such as a laser printer. Each page of such a computer-printed bingo pack is imprinted with several bingo cards (e.g., with a six-on) and is also imprinted with an indication of a bingo game in which the specific bingo page is played. In particular, each page may be imprinted with a name of a bingo game, a name of a bingo pattern being played in the game, highlighted bingo numbers belonging to the pattern, and/or a sequence number of the bingo game in a bingo session.

The individual bingo pages are preferably not manufactured in advance of a bingo session and are not collated in a bingo pack, but rather are printed on-demand at a self-service point of sale terminal or vending kiosk at the time of sale to a bingo player. The individual bingo pages forming such bingo packs are generally printed in sequence (e.g. in the reverse order of the order of bingo games included in a bingo session i.e., last game first and first game last). The printed packs are dispensed to the player as a stack of loose bingo pages starting with the first bingo page to be played in the first bingo game and ending with the last bingo page to be played in the last game. If a player buys two or more packs, all bingo pages played in the same bingo game may be printed sequentially before printing any bingo pages for any other game. If a player buys packs of different levels (denoted by a different color), all bingo pages of the same level for the same bingo game are preferably printed sequentially before printing packs of any different level. The resulting stack of printed bingo pages is arranged in the natural order of playing thus facilitating the spreading or arranging of bingo pages on a playing area at the beginning of a bingo game and making it more convenient to discard played bingo pages at the end of the game.

The self-service kiosk facilitates real-time purchasing of the bingo packs by displaying on a screen a menu of packs available for purchasing. A player pays for the purchased packs by inserting currency bills into a bill validator interconnected with a personal computer that controls the graphics printer printing the packs. Multiple kiosks installed in a bingo hall are preferably networked with a bingo caller terminal serving as a central file server. The networked kiosks report their sales transactions, including each sold bingo pack, to the bingo caller terminal that automatically verifies all sold bingo cards with each new called bingo ball in order to increase the speed of the game and to assure integrity of the game. Over the network, the bingo caller terminal broadcasts bingo session data, such as bingo patterns and called bingo numbers, to all participating kiosks and electronic player units. In addition to paper, bingo card kiosks can optionally dispense electronic bingo cards into hand-held and/or stationary electronic bingo player units.

### BRIEF DESCRIPTION OF THE DRAWINGS

The invention is illustrated by the following drawings:

FIG. 1 illustrates a self-service kiosk dispensing computer-printed bingo packs;

FIG. 2 illustrates a block diagram of a network of computer-controlled pack-printing kiosks;

FIG. 3 illustrates a trailer of a bingo page;

FIG. 4(a) illustrates a sequence of bingo games in a bingo session;

FIG. 4(b) illustrates a sequence of bingo pages in computer-printed bingo packs;

FIG. 5 illustrates a commercial on kiosk's touchscreen with a bonus touch spot;

FIG. 6(a) illustrates a bingo card with highlighted bingo pattern “large bingo frame”;

FIG. 6(b) illustrates a bingo card with pre-marked “bonanza” numbers;

FIG. 6(c) illustrates a bingo card with highlighted “hot ball”; and

FIG. 7 illustrates a refund receipt.

### PREFERRED EMBODIMENT

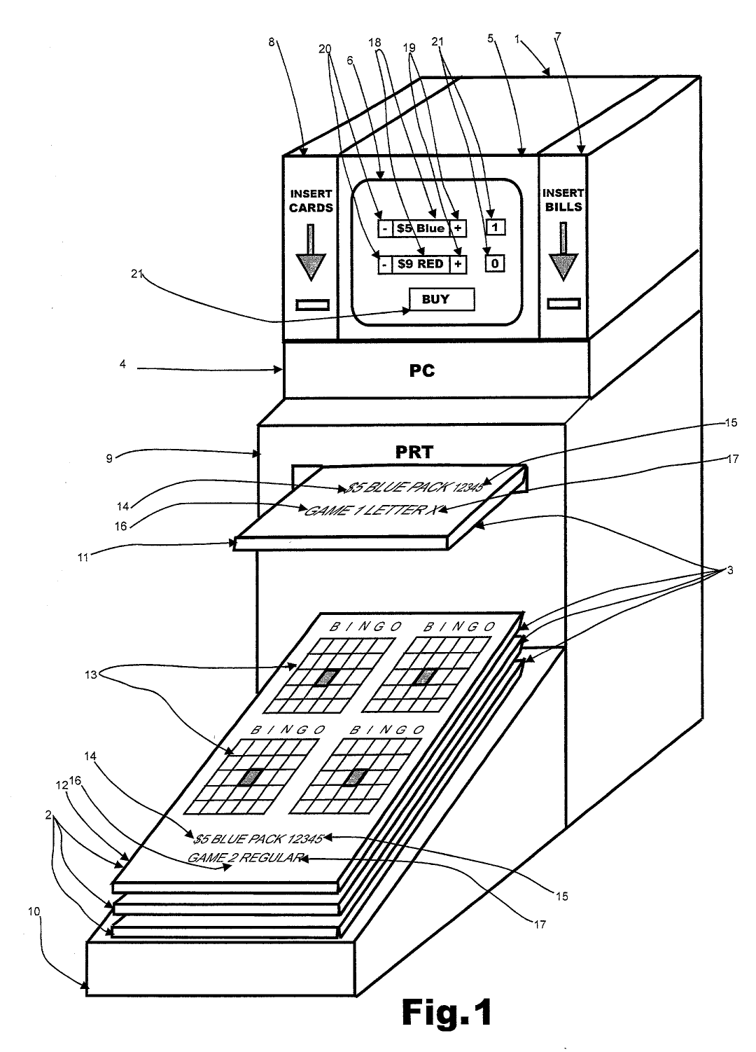

A preferred embodiment of the present invention is illustrated in FIG. 1 wherein 1 is a self-service kiosk dispensing computer-printed bingo pages 2. A collection of bingo pages 2 forms a bingo pack 3. Kiosk 1 includes a personal computer (“PC”) 4, a video monitor 5 having a touchscreen 6, a bill validator 7, a magnetic card reader 8 and a graphics printer 9. Preferably graphics printer 9 is a laser printer equipped with a tray 10 for containing a stack of printed bingo pages 2. For purposes of clarity of presentation, tray 10 is illustrated as an open trapezoid rather than as a pan-shaped object. As shown in FIG. 1, one of the bingo pages 2, namely the bingo page individually numbered 11 is being dispensed from printer 9. A stack of printed bingo pages 2 contained in tray 10 is topped with a bingo page 2 that is also individually numbered 12. The bingo page 12 is imprinted with four bingo cards 13. In addition, bingo page 12 is imprinted with a name of bingo pack 14 (in this case, “$5 BLUE”), bingo pack identification number 15 (in this case, “12345”), a bingo game number 16 (in this case, “2”) and a bingo game name 17 (in this case, “REGULAR”). Bingo page 11 is also imprinted with a name of bingo pack 14 (in this case, “$5 BLUE”), bingo pack identification number 15 (in this case, “12345”), a bingo game number 16 (in this case, “1”) and a bingo game name (in this case, “LETTER X”). Note specifically that bingo game number 16 on bingo page 12 differs by one from bingo game number 16 on bingo page 11 and that bingo game names 17 on bingo pages 11 and 12 are completely different. Touchscreen 6 displays a menu 18 of bingo pack types available for sale (in this case, a “$5 BLUE” pack and a “9 RED” pack). In addition, touchscreen 6 displays touch buttons “+” 19, “−” 20 and “BUY” 21. Also displayed are quantities of each of the two pack types 18 being purchased as shown in counters 21.

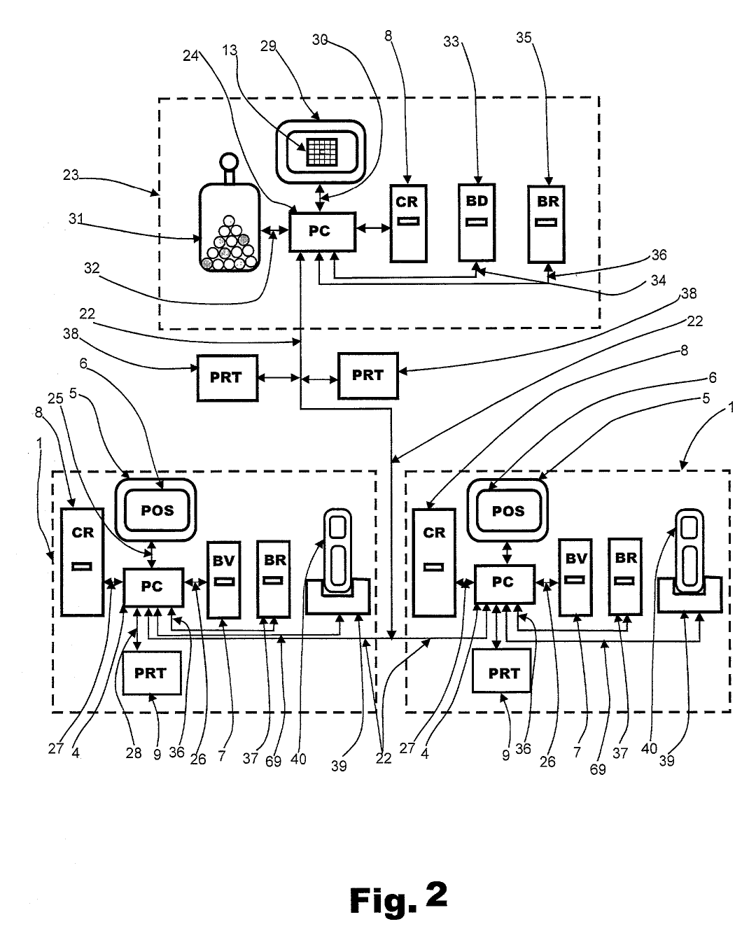

A bingo hall may be equipped with one or more kiosks 1 depending on the size of the bingo hall. Although each kiosk 1 installed in a bingo hall is capable of operating as a stand-alone device, typically multiple numbers of kiosks 1 installed in a bingo hall are networked via Ethernet network 22 as is illustrated in FIG. 2. In addition to kiosks 1, FIG. 2 illustrates a bingo caller terminal 23 networked with each of kiosks 1 via the same Ethernet network 22. FIG. 2 also shows an internal architecture of kiosk 1. As shown in FIG. 2, PC 4 is interfaced with a touchscreen video monitor 5 via a cable 25. PC 4 is also interconnected with bill validator 7 via a cable 26 and with magnetic card reader 8 via a cable 27. In addition, PC 4 is interconnected with graphics printer 9 via a cable 28. Bingo caller terminal 23 is also anchored by a personal computer 24. In addition to PC 24, bingo caller terminal 23 includes a touchscreen monitor 29 (in this case displaying a bingo card 13 being verified) interconnected with PC 24 via a cable 30. Optionally, bingo caller terminal 23 may include a bingo ball blower 31 interconnected with PC 24 via a cable 32, a bill dispenser 33 interconnected with PC 24 via a cable 34 and a barcode reader 35 interconnected with PC 24 via a cable 36. Note that kiosk 1 may also include a barcode reader 37 of its own as shown in FIG. 2. The system illustrated in FIG. 2 may optionally include network printers 38 interconnected with network 22.

The self-service kiosk 1 is designed to be operated by a bingo player. A player initiates operation of kiosk 1 by inserting currency bills in bill validator 7 or optionally a player may also insert his/her credit card and/or player-tracking card into magnetic card reader 8. Subsequently, the player selects the number of specific bingo packs he or she wants to purchase by touching the “+” buttons 19 and observes the total amount of packs 18 being ordered as displayed by counters 21. Should a player overbook the order, he or she can decrement the order by touching the “−” buttons 20. Upon completion of the order, the player touches the “BUY” button 21. In response, PC 4 commands printer 9 to print the purchased bingo packs and dispense a stack of bingo pages 2 comprising player's order as illustrated in FIG. 1. Since the conventional techniques of hardware and software design of self-service vending kiosks and the methods of computer-printing of bingo cards are well known in the industry (see for example, U.S. Pat. Nos. 4,882,688, 4,885,700, 5,607,145, 5,890,432, 5,036,472, 5,546,316 and our co-pending patent application entitled “Wireless wagering system”) they are omitted herein. Instead, it is the unique content of the bingo pages printed by printer 9 under the control of PC 4 that is focused on herein.

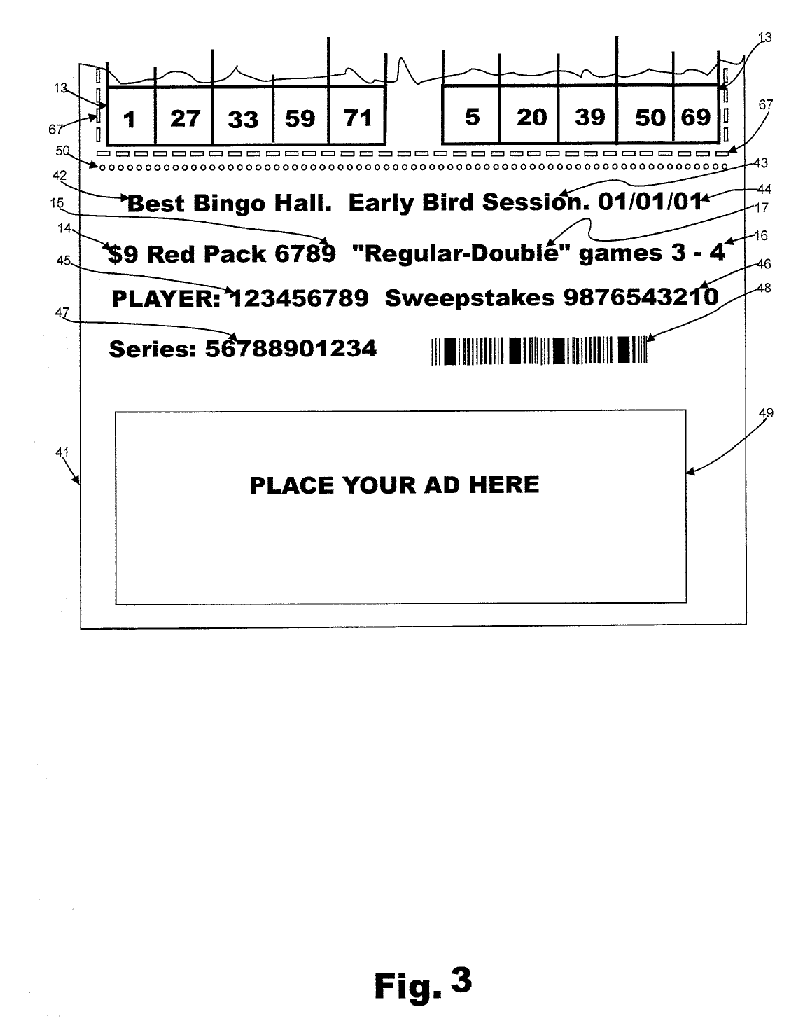

Each of the printed bingo pages 2 is imprinted with at least one bingo card 13. Although bingo pages 2 illustrated in FIG. 1 are imprinted with four bingo cards forming a “four-on”, the most popular format in the bingo industry is a “six-on” and therefore, bingo page 2 will most likely be imprinted with six bingo “faces.” Note that six bingo cards can conveniently be printed on a conventional 8.5″ by 11″ paper page in exactly the same size and format as conventional paper bingo cards. Moreover, sufficient room is available on the same 8.5″ by 11″ paper page (even more so on a 8.5″ by 14″ paper page) for printing of a unique trailer 41 at a bottom or top thereof as illustrated in FIG. 3. Trailer 41 includes a frame 67 around bingo cards 13, a bingo hall name 42, a bingo session name 43, a bingo session date 44, bingo pack name 14, bingo pack number 15, bingo game name(s) 17, bingo game number(s) 16 a player identification number 45, a sweepstakes entry number 46, a series number 47, a barcode 48 and an advertisement 49. As is customary in the bingo industry, bingo pack number 15 uniquely identifies all bingo cards 13 imprinted on bingo page 2 and series number 47 uniquely identifies a manufacturing or printing run. Barcode 48 uniquely identifies the entire bingo page 2. For example, barcode 48 may be a concatenated and/or hashed number consisting of a bingo pack number 15, series number 47 and bingo game number 16. Being separated from the rest of bingo page 2 by perforation 50, trailer 41 serves as a detachable coupon for a sweepstakes entry 46 and as such, promotes retention of the advertisement 49 by a player. The primary purpose of printing an advertising coupon is to offset the cost of printing bingo page 2. The advertisement 49 may be preprinted on the page 2 ahead of printing bingo cards 13 and identifiers 42 through 48. The advertisement 49 may carry a coupon and a unique barcode of its own conducive for redeeming (e.g. at a supermarket point of sale). In addition and/or as an alternative to advertising 49, commercials may be printed on the reverse side of bingo page 2.

In order to facilitate explanation, it is assumed initially that a player buys only one bingo pack 3 and that printer 9 prints pages face-up. Then, it is preferable to print sequential bingo pages 2 forming pack 3 in the reverse order of the order of games in a bingo session (i.e., last game first and first game last as illustrated in FIG. 1). As shown in FIG. 1, bingo pack 3 dispensed by kiosk 1 is automatically arranged in the ascending order of games in the bingo session. A player plays such a pack top-down and simply discards the top page at the end of the current game. Although such a pack is not glued at the top as the conventional packs are, it is nevertheless arranged in the correct order and can be easily stapled together by a player provided a stapler and box of conventional staples is positioned adjacent printer 9. Alternatively, pack 3 may be automatically stapled by a printer 9 equipped with a stapling attachment. Note that if a specific model of printer 9 prints pages “face down”, the order of printing of bingo pages 2 follows the natural order of games in the bingo session.

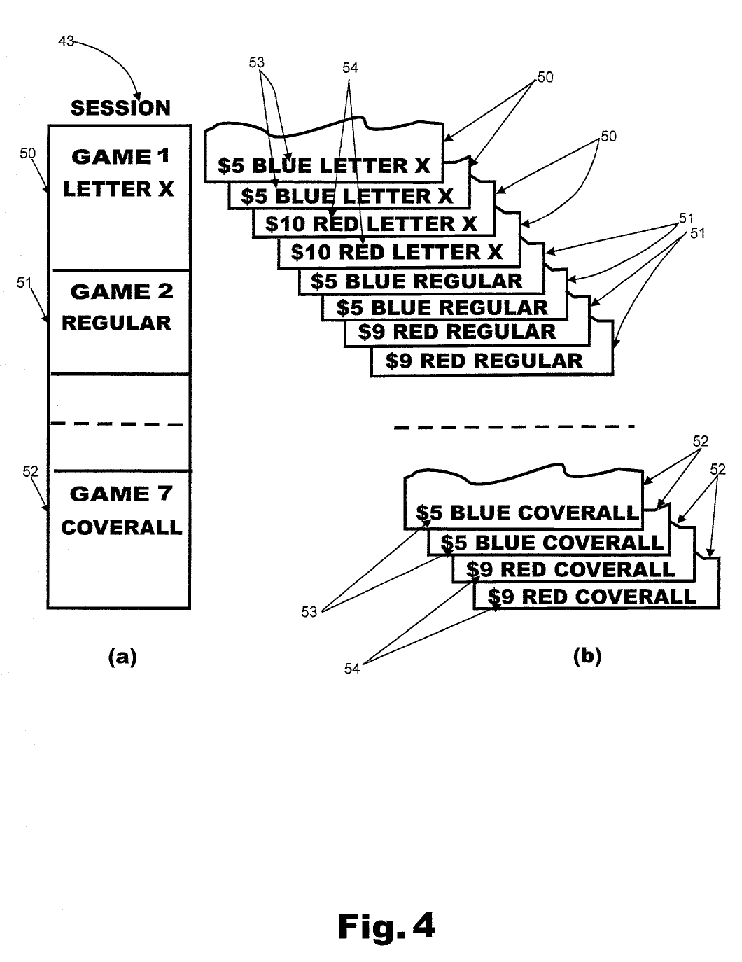

In a case where a player buys two or more packs 3, they can either be printed one after another or their individual bingo pages 2 may be interspersed so that all bingo pages 2 belonging to the same bingo game 16 are printed together as a group prior to printing bingo pages 2 for the next game as illustrated in FIG. 4. Specifically, FIG. 4(a) provides an example of a seven-game bingo session 43 starting with “LETTER X” game 50, followed by “REGULAR” game 51 and ending with “COVER ALL” game 52. FIG. 4(b) illustrates a corresponding stack of bingo pages 2 printed by printer 9 in case where a player buys two “$5 BLUE” packs 53 and two “$9 RED” packs 54. In such a case, printer 9 sequentially prints four bingo pages for each game, namely two “$5 BLUE” pages 53 and two “$9 RED” pages 54 and then, prints four bingo pages 2 for the next game (FIG. 4(b) assumes a “face-down” printer 9). The stack of bingo pages illustrated in FIG. 4(b) is convenient for playing because a player can simply take four consecutive pages 2 from the top of stack, put them next to each other and play the current game. At the end of the game, the player simply discards used bingo pages 2 and takes the next four bingo pages from the stack. Note that alternatively, successively printing each of the multiple bingo packs 3 purchased by a single player has a significant drawback, namely a player has to manually separate the printed packs from the common stack of bingo pages 2. Nevertheless, separation of packs 3 can be facilitated by equipping printer 9 with a conventional sorter-stacker under the control of PC 4. Although the example described above includes only two types of bingo packs, namely “$5 BLUE” 53 and “$9 RED” 54, kiosk 1 may offer players a vast variety of bingo packs by displaying the menu of available bingo packs on touchscreen 6 in a manner similar to illustrated in FIG. 1.

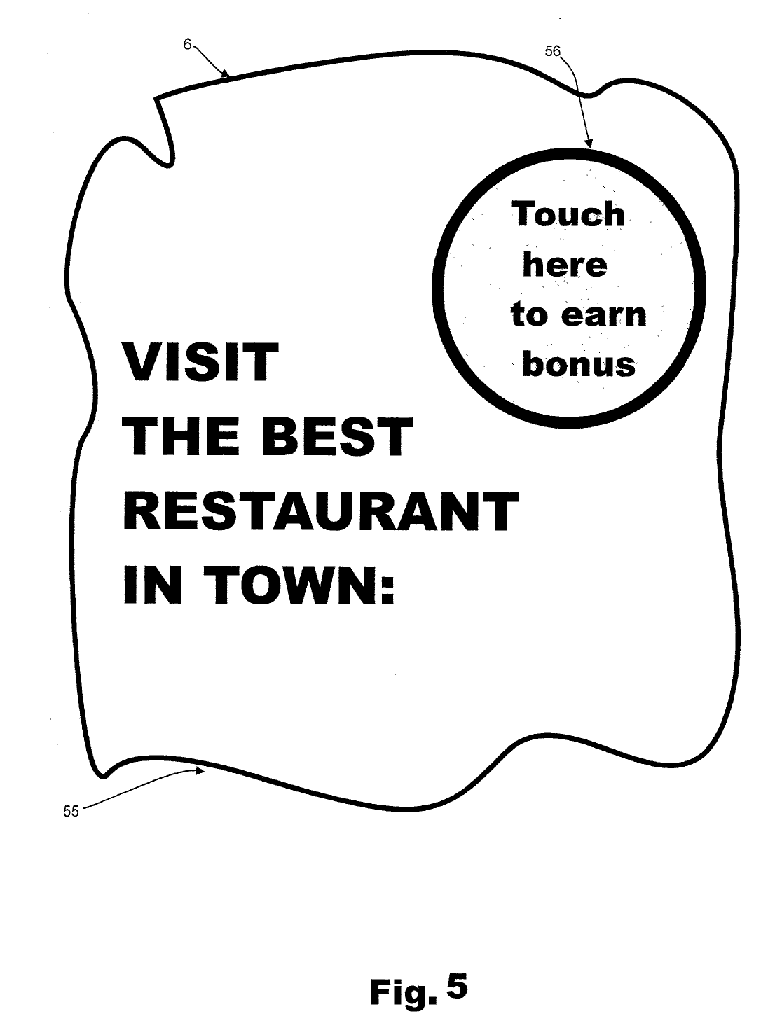

While bingo packs 3 are being printed by printer 9, touchscreen 6 displays commercials, which are optionally, related to the same advertisement 49 that is being printed on bingo pages 2 or to a separate commercial 55 illustrated in FIG. 5. In order to encourage a player's retention of commercial 55 displayed on touchscreen 6, a “bonus spot” 56 appears on the touchscreen 6 at a random location and random time interval as illustrated in FIG. 5. A player is encouraged to touch “bonus spot” 56 in order to earn “bonus points” for his or her player club account and/or earn additional sweepstakes entries 46.

It has been tacitly assumed that printer 9 has only one paper tray and that regardless of the color of the packs all packs 3 are printed in black on white paper. With several paper trays available, each of the trays can accommodate paper of a unique color, and under control of PC 4, printer 9 can print “color packs” on paper of matching color. In the alternative, kiosk 1 may be equipped with several single-tray printers 9 printing packs of only one color each. Note that a total cost and throughput of multiple small-capacity printers 9 may be comparable to the cost of a single high-speed printer equipped with multiple trays and a sorter-stacker.

Although printer 9 prints bingo cards 13 under the control of PC 4 akin to Kondziolka, it does not mandate that cards 13 are generated using Kondziolka's method. Unlike Kondziolka's bingo cards, bingo cards 13 differ from each other by at least two bingo numbers and preferably, by four or more bingo numbers. The severe restriction on selection on bingo cards 13 is imposed purposely in order to restrict the likelihood of undesirable multiple splits of prizes in the bingo hall. Note that if two bingo cards differ from each other by one number, it is very likely that they will both win the same bingo game, especially, a very popular and a very simple “regular” bingo game. PC 4 can generate such a sufficiently diverse perm of bingo cards 13 in two steps. First, it can generate a sufficiently large tentative set of pseudo-random bingo cards and second, it can filter from the tentative set all bingo cards that have less then a desirable degree of diversity (e.g., bingo cards having twenty or more bingo numbers in common). Note that the above-described first and second steps of making a sufficiently diverse perm of pseudo-random bingo cards do not have to be necessarily executed on PC 4 but can be executed on any external computer with the final product of the steps being stored on PC 4 as a file.

Kiosk 1 relays comprehensive data on each sale transaction, including the quantity of each type 18 of bingo pack 3 sold, pack identification numbers 14 and/or center (“face”) numbers 68 of bingo cards 13 to bingo caller terminal 23 via Ethernet network 22. More specifically, PC 4 of kiosk 1 transmits sales transaction data to PC 24 of caller 23 that stores all sales transaction data in an internal database. In particular, PC 24 maintains a database of all sold cards 13 participating in any given bingo game. Therefore, PC 24 can conveniently verify all bingo cards 13 for both a winning bingo pattern and a validity of sale. Moreover, PC 24 can automatically detect each winning bingo card by automatically verifying each and every bingo card 13 participating in a game each time a new bingo ball is called and/or a new bingo pattern 17 is introduced. Details of such an automatic detection of winning bingo cards 13 are disclosed in U.S. Pat. Nos. 5,951,396 to Tawil, 6,257,980 to Santini and our co-pending patent applications Ser. No. 09/940,286 and 60/241,982.

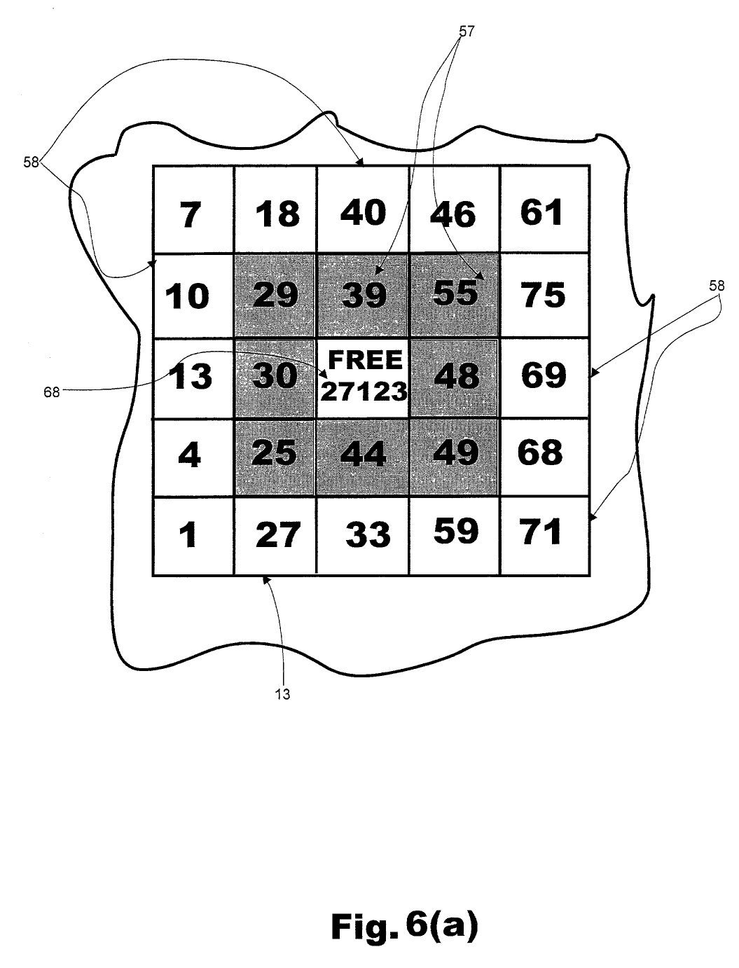

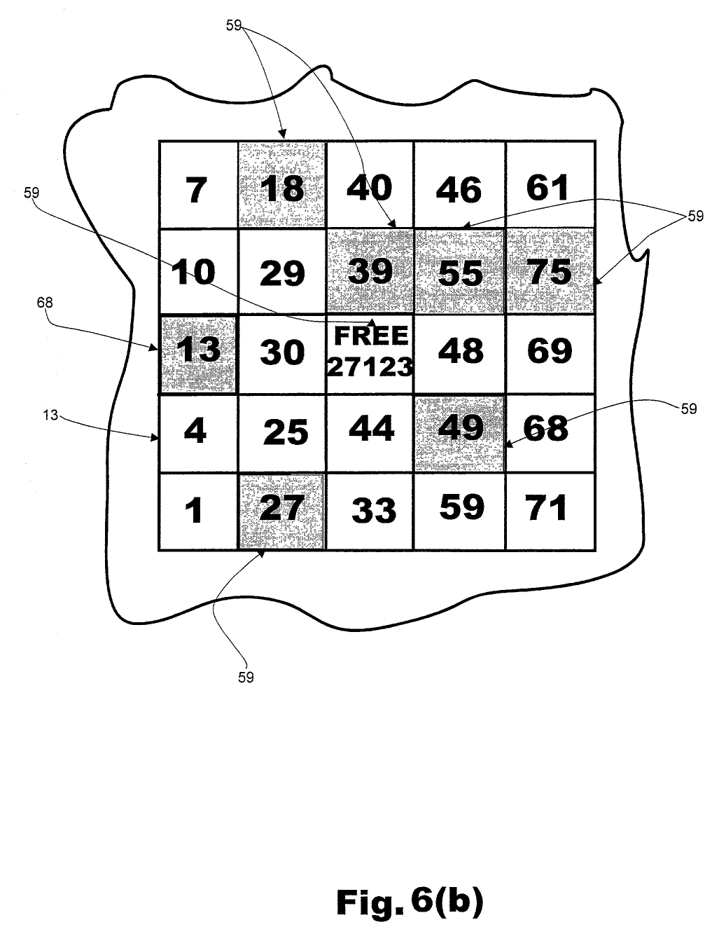

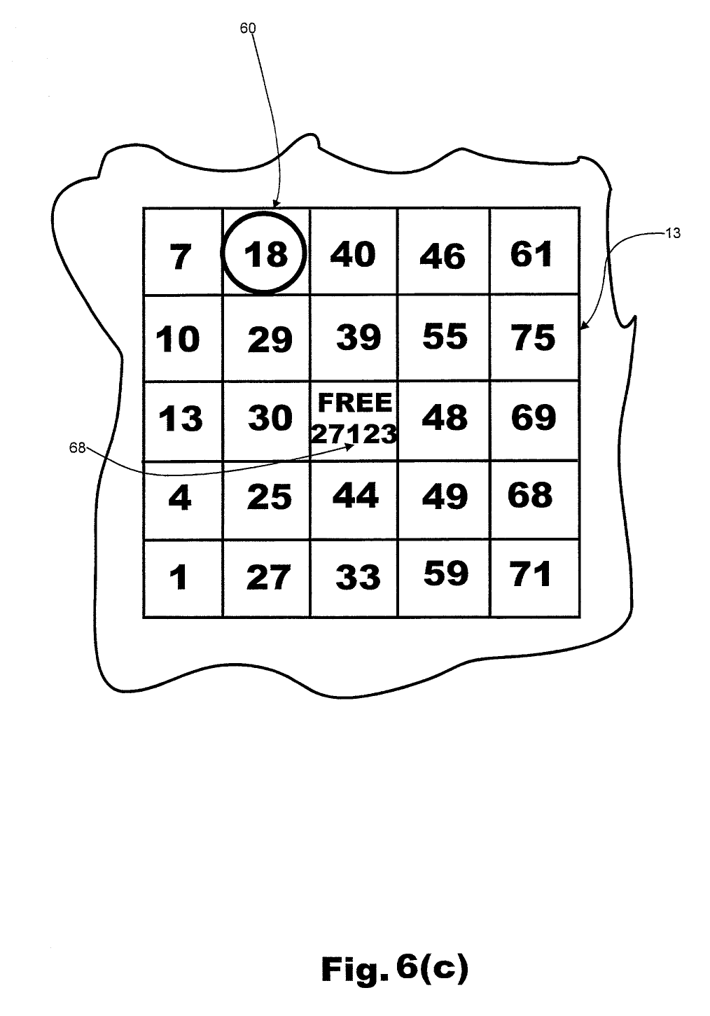

The communication between kiosk 1 and bingo caller terminal 23 over Ethernet network 22 is not limited to one way transmission from PC 4 the central PC 24. The data can flow in the opposite direction as well. Specifically, the central PC 24 can coordinate activities of all kiosks 1 on network 22 by broadcasting data, such as date 44, time 62, called bingo numbers, and bingo schedules including bingo session name(s) 43, bingo game name(s) 17 and bingo patterns, to all participating kiosks 1. Being informed regarding bingo patterns, kiosk 1 can preprint bingo cards 13 with highlighted bingo patterns as illustrated in FIG. 6(a) wherein all bingo numbers 57 outside the “large picture frame” 58 are dimmed. In effect, the bingo numbers contained in “large picture frame” 58 are highlighted and therefore, indicate that the pattern being played is a “large picture frame.” Similarly, being informed regarding called bingo numbers, kiosk 1 can dispense bingo cards 13 with pre-printed “bonanza” bingo numbers 59 as illustrated in FIG. 6(b) wherein a bingo card 13 is preprinted with dimmed bingo numbers 59 that are pre-called prior to the game beginning. The information about pre-called bingo numbers received by kiosk 1 from bingo caller terminal 23 can also be used to preprint a pre-called “hot ball” bingo number 60 as illustrated in FIG. 6(c) wherein an encircled bingo number 60 highlights a “hot ball” bingo number that entitles a player to a large progressive jackpot should the illustrated bingo card 13 become a winning bingo card in a bingo game ending with “hot ball” bingo number 60. The pre-printing techniques illustrated in FIG. 6(a) through 6(c) can be combined together to highlight a desirable combination of attributes of a bingo game (e.g., a “hot ball” 60 could be emphasized within a highlighted bingo pattern 58).

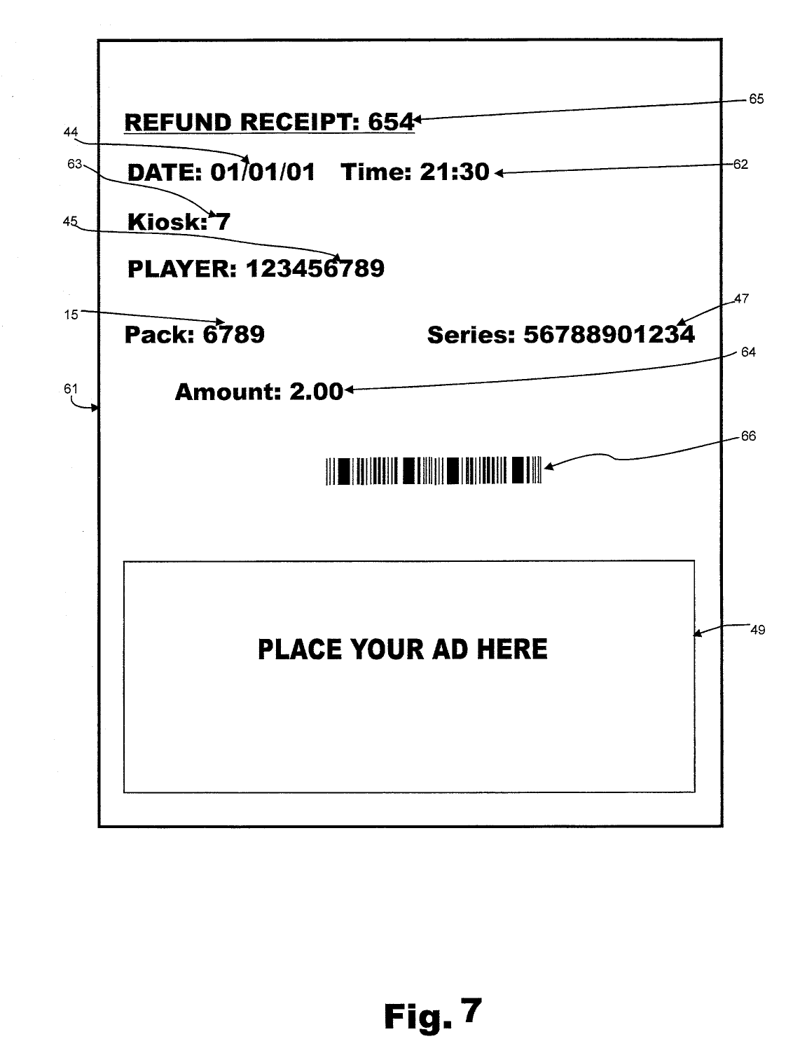

It has been tacitly assumed that a player deposits bills into bill validator 7 equaling the exact cost of all packs being purchased or that the player's purchase is charged to a credit card read by magnetic card reader 8. In a more general case of a player depositing excess funds, the same printer 9 can be used as a vehicle for providing refunds as is illustrated in FIG. 7 showing a refund receipt 61 issued by printer 9 under control of PC 4. The refund receipt 61 of FIG. 7 includes a date 44, a time 62, an identification number of kiosk 63, a player identification number 45, an amount to be refunded 64, a unique receipt identification number 65 and a unique barcode 66 that encodes the information printed on refund receipt 61. The information corresponding to receipt 61 is transmitted by kiosk 1 to bingo caller terminal 23 that acts as a system file server. Terminal 23 stores data corresponding to receipt 61 in a database residing on its PC 24. In particular, refund amount 64 corresponding to barcode 66 is stored in the database. The refund amount 64 is retrieved from the database when barcode 66 is read by barcode reader 35 and relayed to PC 24 via cable 36. In response, PC 24 displays the refund amount on touchscreen 29 and dispenses the refund amount 64 via bill dispenser 33. In the alternative, refund amount 64 displayed on touchscreen 29 may be paid by the operator (e.g. a cashier and/or bingo caller) of terminal 23. A player does not have to refund the amount 64 immediately but may use refund receipt 61 later to, for example, purchase bingo packs 3 for another bingo session. To do so, a player simply has to scan refund receipt 64 using barcode reader 37 integrated into kiosk 1. The barcode 66 read by barcode reader 37 is relayed to PC 4 via cable 36 and subsequently, is relayed by PC 4 to the central PC 24 via Ethernet cable 22. Thereafter, the central PC 24 retrieves the refund amount 64 from its database utilizing barcode 66 as a search key and communicates refund amount 64 to PC 4 which treats refund amount 64 as a credit for the player. Optionally, refund receipt 61 may serve as a title or, in the alternative, as a trailer page to pack 3. Also optionally, refund receipt 61 may be printed on a separate receipt printer capable of printing barcoded receipts of a dollar bill size. Such a receipt can be directly read by bill validator 7.

Having detailed information on each and every sales transaction performed by kiosks 1, bingo caller terminal 23 can assume an additional role of manager of network printers 38. In particular, terminal 23 can cause network printers 38 to print all bingo packs 3 instead of printing bingo packs 3 by each kiosks' local printer 9. Printing of packs 3 on network printers 38 may yield substantial costs savings because networked printers 38 may share printing jobs whereas dedicated printers 9 may not. In order to assist a player in locating his or her packs 3 printed on networked printers 38, touchscreen 6 displays a printer number of a networked printer assigned the printing job. Optionally, a local printer 9 implemented as a small receipt printer issues a receipt to the player with an indication of a specific network printer 38 that prints pack 3 for the player. The printer number is relayed by terminal 23 to issuing kiosk 1 over network 22.

Although the above description focused on various aspects of dispensing paper bingo packs 3 from kiosk 1, the kiosk can be upgraded to dispense electronic facsimiles of bingo cards 13 into electronic bingo player units, such as those disclosed in U.S. Pat. Nos. 4,455,025 and 4,624,462. As illustrated in FIG. 2, kiosk 1 can optionally be equipped with a downloading adapter 39 interconnected with PC 4 via cable 69. Adapter 39 in essence, represents an extension of a conventional serial port of PC 4. Through adapter 39, PC 4 communicates with a portable hand-held electronic bingo player unit 40 while the hand-held unit is plugged into adapter 39. In particular, PC 4 downloads electronic player unit 40 with electronic facsimiles of bingo cards 13 as more fully disclosed in our co-pending patent application Ser. No. 09/940,286. Note that kiosk 1 can optionally download electronic bingo cards in stationary electronic bingo units as well, and that the electronic bingo cards may belong to a perm of bingo cards differing from the perm of bingo cards 13.

It should be understood that although the above description focused on self-service kiosks, a simplified kiosk 1, lacking bill validator 7, can be easily serviced by a cashier. Similarly, it should be understood by a person skilled in the art that the present invention may be embodied otherwise without a departure from the main principles of the invention.

We claim:

1. A bingo pack, printed by a printer responsive to a computer, comprising a plurality of consecutively printed bingo pages;
each said bingo page having printed thereon a reference to a bingo game and at least one bingo card corresponding to said at least one bingo game; and
each said bingo page corresponding to at least one of a plurality of bingo games forming a bingo session.

2. The bingo pack of claim 1 wherein said reference includes at least one of the following:
a name of said bingo game;
a bingo pattern being played in said game; and
a consecutive number of said bingo game in said bingo session.

3. The bingo pack of claim 1 wherein said bingo pack is printed at the time of sale of said bingo pack.

4. The bingo pack of claim 1 wherein at least one of said bingo pages is imprinted with a barcode uniquely identifying said bingo pack.

5. The bingo pack of claim 1 wherein at least one of said bingo pages is imprinted with an identification number uniquely identifying said bingo pack.

6. The bingo pack Combination of claim 1 wherein at least one of said bingo pages is imprinted with a player identification number.

7. The bingo pack of claim 1 wherein at least one of said bingo pages is imprinted with a sweepstakes entry identification.

8. The bingo pack of claim 1 wherein at least one of said bingo pages is imprinted with one or more advertisements.

9. The bingo pack of claim 1 wherein at least two of said consecutively printed bingo pages are played concurrently in at least one of said bingo games.

10. The bingo pack of claim 1 wherein at least two of said consecutively printed bingo pages are printed on different stocks of paper.

11. A plurality of bingo packs of claim 1 printed consecutively by a printer responsive to a computer.

12. The bingo pack of claim 1 wherein each said bingo card being played during a same bingo game in said bingo session is generated by computer means and differs from each other said bingo card for the same game by at least two bingo numbers.

13. The bingo pack of claim 1 wherein at least two of said consecutively printed bingo pages correspond to different prize levels available in said bingo session.

14. The bingo pack of claim 1 wherein said bingo pack is printed at a point-of-sale terminal.

15. The bingo pack of claim 14 wherein said point-of-sale terminal communicates with an electronic bingo player unit for transmitting an electronic facsimile of a bingo card thereto.

16. The bingo pack of claim 14 wherein said point-of-sale terminal is equipped to dispense a plurality of said bingo packs differing from each other by at least one of the following:
a price;
a prize;
a color;
a name; and
a number of said bingo cards.

17. The bingo pack of claim 16 wherein said point-of-sale terminal includes means for displaying said plurality of said bingo packs.

18. The bingo pack of claim 14 wherein said point-of-sale terminal includes means for displaying a menu of said bingo packs available for sale.

19. The bingo pack of claim 14 wherein said point-of-sale terminal is a self-service point-of-sale terminal.

20. The bingo pack of claim 19 wherein said self-service point-of-sale terminal includes means for displaying an interactive commercial and issuing a patron a prize based on an adequate interactive response by said patron to said commercial.

21. The bingo pack of claim 14 wherein said point-of-sale includes means to print, dispense and read a refund voucher.

22. The bingo pack of claim 14 wherein said point-of-sale terminal is networked with a central file server.

23. The bingo pack of claim 22 wherein said central file server verifies a validity of sale of at least one of said bingo cards.

24. The bingo pack of claim 22 wherein said central file server verifies a validity of winning of at least one of said bingo cards.

25. The bingo pack of claim 22 wherein said central file server signals a current status of at least one of said bingo cards based on a bingo pattern being played and bingo numbers being called.

26. The bingo pack of claim 1 wherein at least one of said consecutively printed bingo pages is preprinted with advertising material.

27. The bingo pack of claim 26 wherein at least a portion of said advertising material is preprinted on a back-side of said bingo page.

28. The bingo pack of claim 1 wherein said bingo card is imprinted with characteristics of said bingo game.

29. The bingo pack of claim 28 wherein said characteristics include at least one of the following:
a highlighted bingo pattern; and
at least one pre-called bingo number.

30. The bingo pack of claim 1 wherein said bingo pack is sold at a first point-of-sale terminal and is printed by a printer responsive to a computer shared by said first point-of-sale terminal and at least a second point-of-sale terminal.

31. A method of making a paper bingo pack comprising consecutively printing a plurality of bingo pages using a graphics printer responsive to a computer, each said bingo page having printed thereon a reference to a bingo game and at least one bingo card corresponding to said at least one bingo game; and
each said bingo page corresponding to at least one of a plurality of bingo games forming a bingo session.

32. The method of claim 31 including a vending kiosk having means for displaying a commercial and issuing a prize to a patron based on an adequate interactive response by said patron to said commercial.

33. The method of claim 32 wherein said kiosk dispenses bingo packs printed by a printer responsive to a computer.

34. The method of claim 31 wherein said bingo page is imprinted with a player identification number.

35. The method of claim 31 wherein said bingo page is imprinted with a sweepstakes entry identification.

36. A method of using a bingo page for marketing purposes, said bingo page printed by a printer responsive to a computer, said bingo page imprinted with at least one bingo card and including at least one of the following steps:
(a) imprinting said bingo page with a player identification number and using said player identification number for player tracking purposes;
(b) imprinting said bingo page with a sweepstakes reference and using said sweepstakes reference for promotional purposes; and
(c) imprinting said bingo page with commercial advertising.

37. A method of making bingo packs comprising the following computer-controlled steps:
(a) generating and storing a first plurality of pseudo-random bingo cards;
(b) reducing said first plurality of pseudo-random bingo cards to a second plurality of pseudo-random bingo cards comprising only those first pseudo-random bingo cards that differ from all other pseudo-random bingo cards belonging to said second plurality of pseudo-random bingo cards by at least two or more bingo numbers; and
(c) consecutively printing a third plurality of bingo cards for playing bingo in one of consecutive bingo games forming a bingo session, each of said bingo cards being imprinted with a reference to said bingo game and at least one bingo card corresponding to said second plurality of pseudo-random bingo cards.
